(19) United States
(12) Patent Application Publication
(10) Pub. No.: US 2016/0300218 A1
(43) Pub. Date: Oct. 13, 2016

(54) System and Method for Processing Electronic Charitable Donations

(71) Applicant: Gift Card Giving, LLC, Columbia, MD (US)

(72) Inventor: Kwame Kuadey, Finksburg, MD (US)

(73) Assignee: Gift Card Giving, LLC, Columbia, MD (US)

(21) Appl. No.: 15/094,558

(22) Filed: Apr. 8, 2016

Related U.S. Application Data
(60) Provisional application No. 62/144,661, filed on Apr. 8, 2015.

(51) Int. Cl. G06Q 20/34; G06Q 20/10

(52) U.S. Cl. CPC G06Q 20/342; G06Q 20/10

(57) ABSTRACT

Disclosed is a system and method for processing electronic donations to a designated beneficiary, such as a charitable organization, charitable cause, campaign or individual. Also disclosed are a system and method for automated, mobile device-based donations to a designated beneficiary based on redemption of a gift card, and including software operable on mobile-communications devices and/or stand-alone electronic terminals. The present invention provides the ability for a user to make a charitable donation to one or more designated beneficiaries, including but in no way limited to charitable organizations, in part by utilizing a gift card as the form of donation.

### CROSS REFERENCE TO RELATED APPLICATIONS

This application claims priority to earlier-filed U.S. provisional patent application No. 62/144,661 filed Apr. 8, 2015, the contents each of which are herein incorporated by reference in its entirety.

### BACKGROUND

Stored value, gift, or other pre-paid cards are well-known for providing access to goods and services. In some cases, pre-paid debit cards are printed and issued with a predetermined value and balance, and typically sold as a retail item. An example of one such card is a pre-paid gift card which provides an individual with a set dollar amount for the purchase of goods from a particular merchant. In other cases, a gift card may be printed without a predetermined value, but when it is purchased and activated the customer pays for the amount of money to be “loaded” onto the card. The benefit of gift cards is that they allow the recipients of such gift cards to select their own items of interest. It is not uncommon, however, for gift cards to go unused by the recipient, and by some estimates over $40 billion has accumulated in unused gift card value in the past several years.

### SUMMARY OF THE INVENTION

Described herein is a system and method for processing electronic donations to a designated beneficiary, such as a charitable organization, charitable cause, campaign or individual. Also disclosed are a system and method for automated, mobile device-based donations to a designated beneficiary based on redemption of a gift card, and including software operable on mobile-communications devices and/or stand-alone electronic terminals.

The present invention provides the ability for a user to make a charitable donation to one or more designated beneficiaries, including but in no way limited to charitable organizations, in part by utilizing a gift card as the form of donation. In one aspect of the invention as described herein, an electronic terminal is configured to enable donations via redemption of a gift card. Similarly, one may be able to make a charitable donation using the present invention via a web site, which may or may not be integrated with an e-commerce website, such as at a point-of-sale.

The present invention contemplates that a donor utilizes the value of a gift card as the form of donation. It is envisioned that the donation may be to the benefit of an individual, an organization—such as a school, a non-profit, or 501(c)3 designated organization, or a campaign or other charitable cause.

The gift card is validated and assigned a value, the value of the card is liquidated and the value received upon liquidation becomes the basis of the value for a donation. The donor may direct the value of donation to recipients in one of various manners as described further herein.

Thus, in one aspect the present invention is a method for making a donation to a third party beneficiary, wherein a user elects—via an electronic transaction—to make a donation, using the value associated with a gift card as the means for the donation.

In another aspect there is provided a non-transitory computer-readable medium having recorded thereon a program that causes a portable device to execute a method for generating a charitable donation based on a liquidation of a donor's gift card.

In a further aspect, there is disclosed a portable device comprising: a display; a communication unit configured to receive information associated with a donor gift card; and a processing unit configured to validate and liquidate the value associated with the gift card, and whereby the liquidated value of the card is used as the basis for a donation value to a designated beneficiary.

In yet another aspect, a system is configured to carry out a method for providing a donation to a designated beneficiary, such as a charitable organization or charitable cause, the donation based on redemption of a gift card as form of funds for donation, whereby the system is configured to: receive a request from a gift card holder to donate an amount associated with the value of the gift card, wherein the request may include gift card information and information associated with a charitable cause to receive the donation; validating a balance on the gift card, based in part on the gift card information, and in response to validating the information, retaining redemption rights in the gift card; liquidating the gift card, wherein liquidation includes identifying a purchaser for the gift card and transferring ownership of the gift card to the purchaser to redeem the purchased gift card in exchange for an agreed upon price for the gift card; receiving payment associated with liquidation of the gift card via transferring and/or depositing an amount of the payment received to an account designated; and optionally, further comprising; initiating a transfer of all or a portion of the liquidation funds to the designated beneficiary as the recipient of the funds; and, optionally, retaining a processing fee from the liquidation funds from the amount donated and/or transferred to the designated recipient.

In one aspect a non-transitory computer-readable medium having recorded thereon a program that causes a processor to execute a method for processing a charitable donation based on liquidation of a gift card, wherein the method comprises: receiving information associated with a gift card, wherein information comprises merchant information, numerical identifying information, expiration information, authorization codes, or any other identifying information associated with a merchant issued gift card; validating the gift card balance, wherein validation comprises validating the authenticity of the card and the current balance available in dollars or other common currency; liquidating the validated gift card, wherein liquidating comprises a transaction whereby a third party purchases the value of the gift card for an agreed upon value, such as by auction or over an exchange, and the sale price is deposited into an account for future retrieval; transmitting all or a portion of the liquidated value by transferring funds from the account to a designated charitable organization in order to make a donation to the charitable organization; retaining a portion of the funds from the liquidation, thereby collecting a processing fee; sending an acknowledgment of the donation, such as a receipt by electronic means to the donor who donated the gift card, or storing the acknowledgment for later retrieval.

In another aspect a system for processing a transaction comprising a charitable donation to a beneficiary, the donation based on the liquidation of a gift card, the system comprises: a gift card; a beneficiary; a portable electronic device configured with a web interface, the web interface configured to receive an identifier of a gift card, wherein identifier refers to one or more identifying information of a gift card, including but not limited to a serial number, a card number, a merchant number, a personal identification number; and a donation module residing on a server in communication with the portable electronic device and one or more databases, the donation module comprising a balance validation module configured for validating a balance associated with a gift card, a liquidation module configured for liquidating a validated gift card via a gift card clearinghouse, and a processing module configured for processing an electronic transfer of the donation to the beneficiary, wherein the donation value is based on a liquidation value received upon liquidating the validated gift card for a market value, and wherein the donation comprises a transfer of at least a portion of the liquidation value of the gift card to the beneficiary.

In yet another aspect a method for generating a charitable donation based on a donor's gift card, the method comprises: receiving information associated with the donor's gift card, wherein information comprises merchant information, numerical identifying information, expiration information, authorization codes, or any other identifying information associated with a merchant issued gift card; validating the gift card balance, wherein validation comprises validating the authenticity of the card and the current balance available in dollars or other common currency; liquidating the validated gift card, wherein liquidating comprises a transaction whereby a third party purchases the value of the gift card for an agreed upon value, such as by auction or over an exchange, and the sale price is deposited into an account for future retrieval; transmitting all or a portion of the liquidated value by transferring funds from the account to a designated beneficiary in order to make the charitable donation; retaining a portion of the funds from the liquidation, thereby collecting a processing fee; sending an acknowledgment of the donation, such as a receipt by electronic means to the donor who donated the gift card, or storing the acknowledgment for later retrieval.

### BRIEF DESCRIPTION OF THE DRAWINGS

FIG. 1. provides an overview of a method and system according to one embodiment of the invention for processing a donation to a beneficiary based on liquidation of a gift card.

FIG. 2 provides an overview of a method and system configured with a shopping cart API according to one embodiment of the invention.

FIG. 3 shows an overview of a method for processing an electronic transaction to a beneficiary based on a gift card donation, according to one embodiment of the invention.

FIG. 4 shows an overview of a web-based method for processing an electronic transaction to a beneficiary based on a gift card donation, according to one embodiment of the invention.

FIG. 5 shows an overview of a system for processing a donation to a beneficiary based on liquidation of a gift card.

### DETAILED DESCRIPTION OF THE INVENTION

As used herein, gift card can generally refer to a card that resembles a credit card, but has a pre-determined monetary equivalent (i.e., a face value). A gift card typically includes a gift card identifier (e.g., a number, etc.) that is cross-linked to the gift card's face value. Gift cards can include barcodes, magnetic stripes, processors (e.g., smart chips), and/or other media for recording gift card identifiers, codes, values, and/or other suitable information. As used herein, the term “gift card” can also encompass virtual gift cards that can be delivered via email, text messages or mobile phone applications (e.g., iPhone applications) and displayed using a smart phone, tablet, and/or other suitable devices. Gift cards may be open loop or closed loop cards. Banks or credit card companies can issue open loop cards that can be redeemed at different commercial establishments. Conversely, restaurants, stores, and other retail establishments generally issue closed loop cards that are only valid for use at the retail establishment or its retail partners.

As shown in the Figures, provided as illustration and not limitations, the present invention is embodied in a method and system for processing a charitable contribution. In the following description like numerals refer to like elements in the Figures.

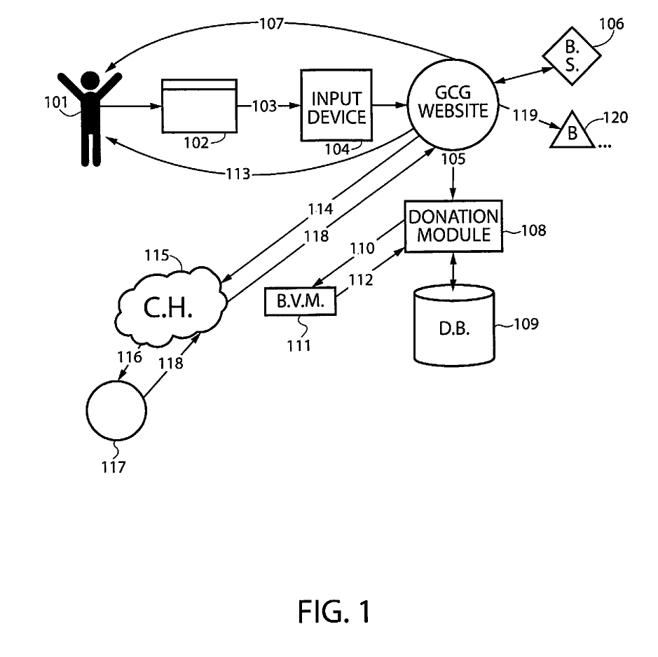

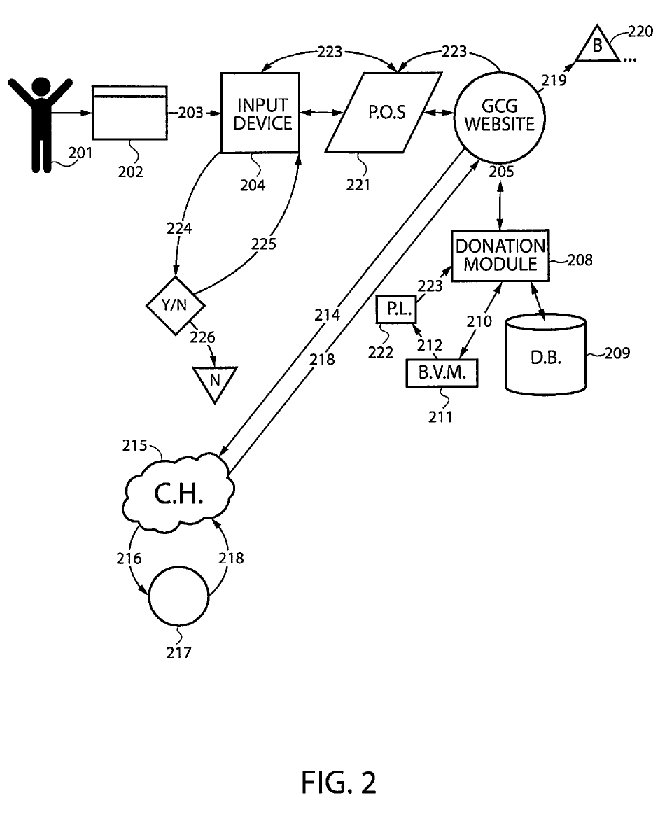

Below is listed, in Table I, a reference table for FIGS. 1 and 2. Reference numbers beginning with the numeral “1” refer to components/elements of FIG. 1, and reference numbers beginning with the numeral “2” refer to components/elements of FIG. 2.

TABLE I

| Ref # | Description |
|---|---|
| 100/200 | System |
| 101/201 | Donor |
| 102/202 | Gift Card |
| 103/203 | GC Identifier (Merchant Name, Serial #, & Pin #) |
| 104/204 | Input Device |
| 105/205 | GCG Website |
| 106/206 | Beneficiary Selection |
| 107/207 | Acknowledgement Email to Donor &/or 50% Email to |
| | Campaign Participant |
| 108/208 | Donation Module |
| 109/209 | Database (s) |
| 110/210 | Verification Process |
| 111/211 | Balance Validation Module |
| 112/212 | Validated Value |
| 113/213 | Tax Donation Email to Donor &/or Final Credit to Campaign |
| | Participant |
| 114/214 | GC Liquidation Process |
| 115/215 | Clearing House (Examples: Cardpool.com, GiftCardRescue.com, |
| | Raise.com) |
| 116/216 | Market Value Sell |
| 117/217 | Sale Process |
| 118/218 | Liquidated Value |
| 119/219 | EFT/Payment |
| 120/220 | Beneficiary |
| 121/221 | Point of Sale |
| 122/222 | Pricing Lookup |
| 123/223 | Market Value Buy |
| 124/224 | Donor Sell Decision |
| 125/225 | Proceed with Transaction |
| 126/226 | Cancel Transaction |

There are various embodiments and configurations for implementing the present invention. One such implementation is shown in FIG. 1, where according to one embodiment of the invention, a system 100 includes a device 104 configured with a website interface 105; a donation module 108 in communication with one or more databases 109; a balance validation module (BVM) 111 in communication with the donation module 108 and database 109; a processing service/clearinghouse 115; a beneficiary 120 receiving a donation based, in part, on a liquidated value of a gift card 102. In one embodiment, the device 104 comprises a portable electronic device, such as a laptop, desktop, smartphone or tablet computer, or a stand-alone device, such as a kiosk. The portable device comprises input means, one or more processors, output means, memory, and configured for communication over a network with one or more servers whereon may be housed the donation module, the BVM module and one or more databases. In another embodiment, databases comprise external databases and servers, such as cloud-based servers. In yet another embodiment, the interaction between the donation module (108) and balance validation module (111) is an algorithm which is comprised of the verification processes (110 & 112).

FIG. 1 also shows an overview of a method for processing an electronic donation to a beneficiary, the method compromises of receiving an identifier 103 for a gift card 102 through an input device 104 in communication with the website interface 105; selecting a beneficiary 106; acknowledging the donation by sending an acknowledgment receipt 107 to donor 101; transmitting the identifier 103 to a donation module 108; initiating a verification process 110; validating a value pre-loaded to the gift card via a balance validation module (BVM) 111 configured to verify a card value; communicating a validated card value 112 to donation module 108; initiating a liquidation process 114 by transmitting the validated gift card to a clearinghouse 115, wherein liquidation comprises determining a market value 116; processing a sale 117 of a validated gift card, thereby liquidating the validated gift card for a market value corresponding to the demand for the gift card at the time of the transaction; determining a liquidated value 118 based on the market value for which the sale was processed; initiating a donation to the beneficiary 120 wherein the donation is an electronic funds transfer 119 and wherein the amount of the donation, in U.S. dollars, is based on the liquidated value 118 of the gift card 102 (less processing fees).

In one embodiment, the identifier for the gift card comprises one or more of the gift card number, the merchant identification number, the gift card activation code and/or the personal identification number associated with the gift card, as well as the currency value associated with the gift card. Identifier may be received by manual entry into the device, such as by a keyboard, or electronically, such as read from the magnetic strip of the gift card. In another embodiment, identifying information may be received by capturing an image of the gift card, such as by a card information is read via a camera that takes a picture of the gift card and identifies the gift card information. In one embodiment, upon receipt of the gift card identifier a record of the identifier is created in memory.

In one embodiment, a verification process comprises verifying a value associated with the gift card, and assigning a value to a validated gift card. Verification comprises comparing an identifier corresponding to a gift card to a database of gift card records, wherein the process may be carried out manually or electronically by directly accessing one or more merchant databases. In one embodiment, verification comprises sending a gift card identifier via a balance validation module to a third party database, where the identifier is received and compared to a gift card registry. The third party database returns a validated value based on the gift card identifier provided. Once validated, the gift card is assigned a numerical value, wherein the value is represented by currency.

In another embodiment, a liquidation process is also carried out, whereby a validated gift card is offered for sale by a clearinghouse (or, third party service). The clearinghouse determines the market value (or, the value in which the card will be liquidated at) based on the gift card identifier. In one embodiment, liquidation comprises a sale process initiated by transmitting a validated gift card value to a clearinghouse and receiving a liquidated value upon completion of a sale of the validated gift card to a purchaser via the clearinghouse.

In another method for processing an electronic donation to multiple beneficiaries, based on one or more preferences designated by a donor, comprises receiving an identifier for a gift card via input means on a portable electronic device, the device configured with a website interface; selecting, via the website interface, one or more beneficiaries based on one or more percentages set by the donor; transmitting the identifier to a database; initiating a verification process; validating a value via a balance validation module (BVM); generating an electronic tax donation acknowledgment; communicating the tax donation acknowledgement via the website interface to the donor; liquidating a gift card value via a liquidation process utilizing a clearinghouse; determining a market value of a validated gift card; processing the sale; determining a liquidated value; initiating the one or more donations to the selected beneficiaries based on the percentage preferences set by the donor wherein the donations are an electronic funds transfer and wherein the amount of the donations, in U.S. dollars, are based on the liquidated value of the gift card less processing fees.

In one embodiment, a beneficiary selection process is carried out, whereby a donor selects the beneficiaries in which their donation should be distributed. Beneficiary selection compromises of the donor selecting two or more beneficiaries they would like their donation disbursed to and setting percentage values for each selected beneficiary. Once the liquidated process has completed by the clearinghouse and liquidated value is determined, the donation will be disbursed (via electronic funds transfer) to the selected beneficiaries based upon their set percentages by the donor.

In another embodiment, a method for processing an electronic donation to a beneficiary, via an intermediary beneficiary, wherein the intermediary beneficiary is a web-based fundraising page for an individual participating in an event-based campaign, the method comprising: receiving an identifier for a gift card by input means on a portable electronic device, the device configured with a website interface; selecting a beneficiary; receiving the identifier on a donation module and transmitting the identifier to a balance validation module; initiating a verification process; validating the value of a card via the balance validation module (BVM), thereby generating a validated value; generating an electronic tax donation acknowledgment; generating a donation credit notice for a percentage (for example: fifty percent (50%)) of the validated value to the intermediary beneficiary, wherein the intermediary beneficiary is the individual participating in the event-based campaign; liquidating the gift card via a clearinghouse, wherein liquidation comprises determining a market value of the validated card, offering the card for sale, and processing the sale; determining a liquidated value of the validated card, and wherein the liquidated value is greater than the previously provided donation credit notice (for example: fifty percent (50%)) of the validated value, submitting an electronic final donation credit notice acknowledgment via a web-based interface and communicating the donation credit notice acknowledgment to the individual participating in the event-based campaign; initiating the donation to the individual participating in the event-based campaign, wherein the donation is an electronic funds transfer and wherein the amount of the donation, in U.S. dollars, is based on the liquidated value of the gift card, less processing fees.

In one embodiment, a system is configured to process a point of sale transaction utilizing a gift card for one or both of a purchase of goods/services from a fundraising website, or a donation via the fundraising website. Turning to FIG. 2, which shows an overview of a system and method for processing a point of sale purchase and/or donation via a fundraising website based on a gift card. In one embodiment, the fundraising website is a website designated for the benefit of a charitable organization, a charitable event, or other non-profit entity or cause.

In one embodiment, a method comprises receiving an identifier 203 for a gift card 202 via input means on a portable electronic device 204 configured with a point of sale 221 (a payment terminal; a website shopping cart; or the like) and a website interface 205; transmitting the identifier 203 to a donation module 208; initiating a verification process 210; validating a validation value via a balance validation module (BVM) 211; determining a donation market value rate 225 for a validated gift card via a pricing database configured with a pricing lookup engine 222, the pricing database configured with a pricing engine utilizing one or more algorithms to correlate supply and demand of a gift card and determine a market value for the sale of the gift card; communicating the donation market value 223 to the donor via the website interface 205; presenting to the donor a decision to proceed 224 with a transaction 225, wherein the transaction is a purchase or donation at a point of sale based on the donation market value rate of the gift card, or cancel the transaction 226; proceeding, upon selection by the donor, with the transaction to purchase, or donate, at the point of sale; prompting, to the donor, the donation market value rate to be applied to a transaction amount due, wherein the transaction amount due represents an amount due on a purchase or an amount of a donation, and wherein the prompt is an alert to the donor of the donation market value of the gift card to be applied to the purchase or donation at the point of sale; liquidating via a liquidation process 214 the gift card via a clearinghouse 215; determining a liquidation market value 216 of the gift card offered for sale by the clearinghouse; processing the sale 217 of the validated gift card to be liquidated based on the market value; determining a liquidated value 218; initiating a donation to the beneficiary 220 wherein the donation is an electronic funds transfer 219, and wherein the amount of the donation, in U.S. dollars, is based on at least one of the liquidated value of the gift card or the donation market value of the gift card, less processing fees.

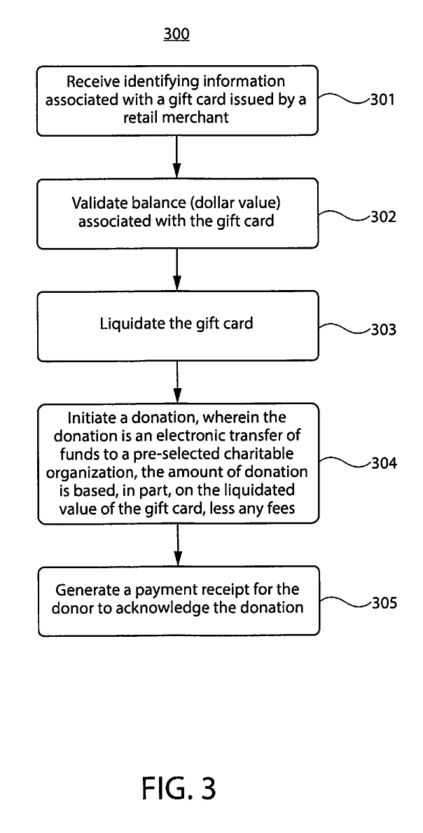

FIG. 3 shows an overview of a method 300 for processing a donation transaction to a beneficiary. The method comprises receiving an identifier for a gift card, at step 301; validating a balance associated with the gift card, at step 302; liquidating the gift card, at step 303; initiating a donation to a beneficiary, wherein the donation is an electronic transfer of funds to the beneficiary and wherein the amount of the donation, in U.S. dollars, is based (partly) on the liquidated value of the gift card, at step 304; and generating an electronic receipt for the donor acknowledging the donation, at step 305.

In one embodiment, the identifier for the gift card comprises one or more of the gift card number, the merchant identification number, the gift card activation code, serial number and/or the personal identification number associated with the gift card, as well as the currency value associated with the gift card. Identifier may be received by manual entry into the device, such as by a keyboard, or electronically, such as read from the magnetic strip of the gift card by a device configured to read magnetic storage and/or configured to read a bar code or SKU. In one embodiment, upon receipt of the gift card identifier, a record of the identifier is created in memory.

In one embodiment, validation of the gift card value comprises, comparing the gift card identifier to a database of gift card records, which may be carried out manually or electronically. In one embodiment, validation comprises sending a gift card identifier to a gift card registry database, where the identifier is received and compared to the gift card registry. The value associated with the gift card in the gift card registry is assigned to the identifier, thereby generating a validated gift card value. Once validated, the gift card is assigned a numerical value (validated value), wherein the value may be represented by currency.

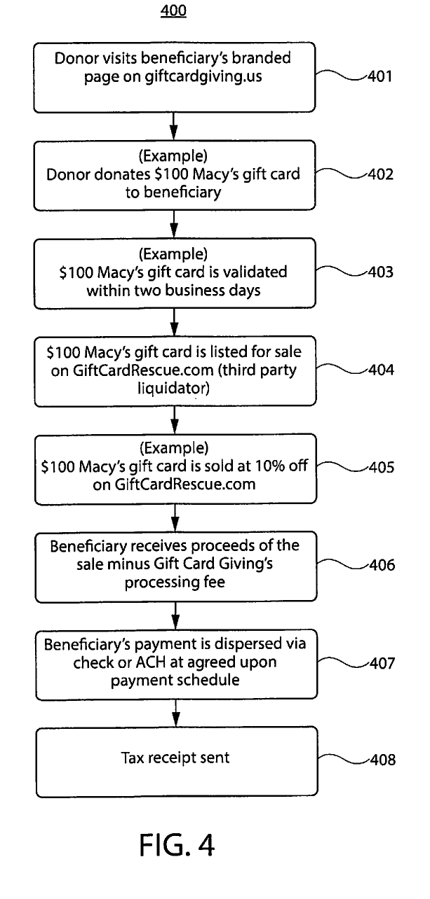

FIG. 4 shows an overview of a method 400 for processing a charitable donation according to another embodiment of the invention. The method 400, comprises receiving a request on a portable electronic device to process a donation to a designated beneficiary via a web-based portal (here shown as a webpage giftcardgiving.us) at step 401; submitting gift card identifying information, here shown as a Macy's department store gift card, with a current value of $100, at step 402; validating the gift card by sending a validation request comprising the gift card identifying information from portable device to a database, which queries the gift card identifying information against a gift card registry comprising a set of valid gift card accounts pre-stored in the database, thereby confirming the gift card is valid, activated and an amount associated with the card is then returned to a system database and stored as a validation value, at step 403; liquidating the validated gift card by offering the validated gift card for sale on an on-line marketplace, or via a third-party clearinghouse, at step 404; liquidating the validated gift card for a liquidation value, by completing a sale transaction to sell the validated gift card to a purchaser, at step 405; calculating a donation value based on the liquidation value (less any processing or handling fees assigned to the transaction), at step 406; sending a payment to the designated beneficiary, either manually or by an automated or electronic payment generated from the system, at step 407; sending a tax receipt to the donor to acknowledge the donation, which may be sent electronically, such as by email or text, from the system database to the donor, at step 408.

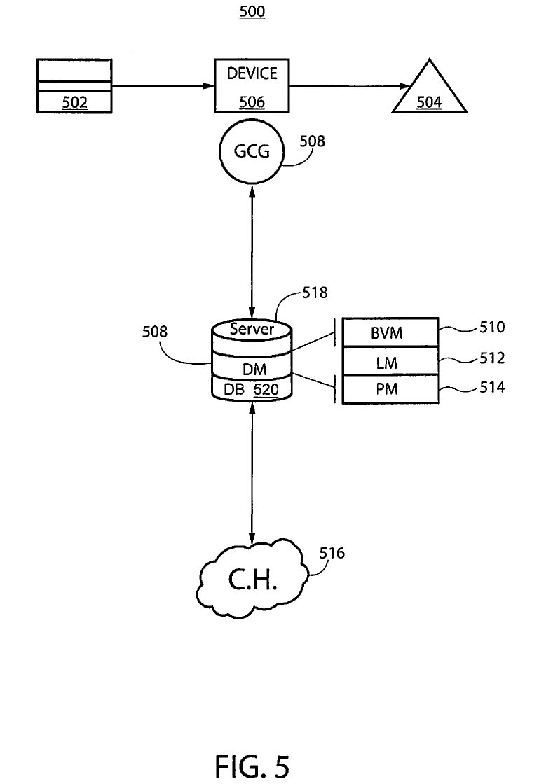

Shown at FIG. 5, is a system 500 for processing a transaction comprising a donation to a beneficiary, the transaction based on the liquidation of a gift card. System 500 comprises a gift card 502 (the gift card having a residual value pre-loaded on the gift card); a beneficiary 504; a portable electronic device 506 configured with a web interface 508, the web interface 508 configured to receive an identifier of a gift card, wherein identifier refers to one or more identifying information of a gift card, including but not limited to a serial number, a card number, a merchant number, a personal identification number; and a donation module 508 residing on a server 518 in communication with device 506 and one or more databases (DB) 520, the donation module 508 comprising a balance validation module 510 configured for validating a balance associated with a gift card and assigning a donation value to the gift card or gift card identifier, a liquidation module 512 configured for liquidating a validated gift card via a gift card clearinghouse 516, and a processing module 514 configured for processing an electronic transfer of the donation to the beneficiary, wherein the donation value is based on a liquidation value received upon liquidating the validated gift card for a liquidation market value, and wherein the donation comprises a transfer of at least a portion of the liquidation value of the gift card to the beneficiary.

One illustrative example of a web-based donation process utilizing a value from a gift card as a donation value is described below. While the process is presented in the form of sequential steps, it will be understood by one skilled in the art that steps may occur in an order other than as specifically presented, and that certain steps may be condensed into a single step, or steps may include various sub-steps, depending on the arrangement of the system and parameters such as connectivity, pre-established relationship with designated beneficiary, etc.

### EXAMPLE

Utilizing the system of the present invention, a donor in custody of a store brand gift card selects a beneficiary to receive a donation, wherein selection may be based on a pre-populated list of charitable organizations, or based on a user providing a designated charitable organization as beneficiary. For example: A Macy's gift card with a face value of $100 is used to effectuate a donation to a designated beneficiary, for example: The Red Cross, or the Parent-Teacher Organization at a local school, or a Medical Fund for a patient's medical treatment or procedure. In one embodiment, the selection of the beneficiary is made via an interface on a device configured with an application for processing a charitable donation according to the present invention.

Gift card information is received via manual input by the donor or received by automated means, such as a wireless payment-based system, a scanner, or magnetic reader. The system receives the value associated with the card and the card details, such as merchant, and merchant identifying information associated with the card, and stores a record thereof in a database of the system.

The system then verifies via a query to a third party provider, or directly to the merchant provider, that the value on the card is accurate. The system then stores the validated value of the card.

The system then initiates a liquidation transaction, soliciting third party offers to purchase the gift card based on the validated value. Liquidation comprises transferring gift card identifying information to a Liquidator/Purchaser for liquidation on a third-party marketplace, who then facilitates the sale of the validated gift card. Upon liquidation, the system calculates a donation value based on the liquidated amount less any fees associated with the transaction. A donation is then sent electronically to the designated beneficiary. The donation comprises the full liquidated price of the card, or the liquidated value less a handling or processing fee collected by the system, or a flat rate based on other factors. A confirmation receipt is then sent to the donor via electronic means from the system to the donor, preferably via email, as confirmation of the donation, donation amount, and beneficiary.

Within the system are various sub-systems, such as a Verification System; an In-House System; Manual Verification System; and Liquidation System.

Validation comprises third-party validation, system configured validation, and/or manual validation. Third party validation comprises sending gift card-associated information received on the system from the system to a third party database, wherein information regarding the gift card is queried against the third-party database of gift card information, and receiving from the third-party database, confirmation that the gift card is valid (which may comprise the absence of an error message, which would otherwise be received/sent back to the system if the gift card information was invalid) and the balance information regarding the gift card. Alternatively, the system can be configured to send a query for gift card associated information directly to a merchant's database in order to confirm and retrieve gift card balance details. Alternatively, a merchant gift card database can be contacted directly, either by phone call, electronic mail or messaging, or link to the merchant database, in order to query for gift card balance information.

Liquidation comprises transmitting card information to a liquidator, wherein a liquidator is a third-party service, a gift card exchange, or an on-line auction or sale site, whereby a transaction can occur to offer the gift card for sale and to facilitate a purchase of the gift card. The sale price of the card is then transferred to an account associated with the system. The funds are then used as the basis for the charitable donation, wherein the donation may be all or a portion of the sale price of the gift card (liquidated value). Alternatively, the donated value may be the liquidated value minus a processing fee for processing the transactions.

In another embodiment, the system further comprises a pricing database configured with a pricing engine utilizing one or more algorithms for analyzing and processing the liquidation of a gift card, including correlating supply and demand of a particular gift card offered for sale on a market such as a gift card clearinghouse.

In one embodiment, the system device (such as kiosk, or other portable device) is configured to include a user interface, one or more output devices, a display screen, and one or more input devices, such as a card input slot or other form of card reader. Additionally, the input device can include a keyboard, a bar code reader, an encrypted PIN pad, a voice command device, a cursor control device, a mouse, and/or other suitable input devices that enable or facilitate entering information. In various embodiments, the display screen can display options related to designated beneficiaries, listing of charitable organizations, or provide means for a user to input information, such as a “beneficiary account”. Beneficiary data that is pre-populated or collected can be stored in a remote database connected via a communications link. In an alternative embodiment, the information can be stored locally on a hard drive or another storage device within the device. Consumers can browse with the user interface using parameters such as organization or beneficiary name, and/or other suitable browsing parameters.

In another embodiment, the system is configured with communication links in order to connect the system and device to third party service providers, such as gift card exchange service providers and/or to financial institutions (e.g., a bank, automated clearing house (ACH), etc.) and retail establishments. The financial institution can perform credit and/or debit card transactions, provide payment options and/or to identified beneficiaries. The retail establishment can provide information regarding gift card balances, gift card usage, etc.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other arrangements, configurations or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, embodiments or examples of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with this disclosure in connection with this application, and the contents of all such papers and documents are incorporated herein by reference.

1. A non-transitory computer-readable medium having recorded thereon a program that causes a processor to execute a method for processing a charitable donation based on liquidation of a gift card, wherein the method comprises:
receiving information associated with a gift card, wherein information comprises merchant information, numerical identifying information, expiration information, authorization codes, or any other identifying information associated with a merchant issued gift card;
validating the gift card balance, wherein validation comprises validating the authenticity of the card and the current balance available in dollars or other common currency;
liquidating the validated gift card, wherein liquidating comprises a transaction whereby a third party purchases the value of the gift card for an agreed upon value, such as by auction or over an exchange, and the sale price is deposited into an account for future retrieval;
transmitting all or a portion of the liquidated value by transferring funds from the account to a designated charitable organization in order to make a donation to the charitable organization;
retaining a portion of the funds from the liquidation, thereby collecting a processing fee;
sending an acknowledgment of the donation, such as a receipt by electronic means to the donor who donated the gift card, or storing the acknowledgment for later retrieval.

2. A system for processing a transaction comprising a charitable donation to a beneficiary, the donation based on the liquidation of a gift card, the system comprising:
a gift card;
a beneficiary;
a portable electronic device configured with a web interface, the web interface configured to receive an identifier of a gift card, wherein identifier refers to one or more identifying information of a gift card, including but not limited to a serial number, a card number, a merchant number, a personal identification number; and
a donation module residing on a database in communication with the portable electronic device, the donation module comprising a balance validation module configured for validating a balance associated with a gift card, a liquidation module configured for liquidating a validated gift card via a gift card clearinghouse, and a processing module configured for processing an electronic transfer of the donation to the beneficiary,
wherein the donation value is based on a liquidation value received upon liquidating the validated gift card for a market value, and wherein the donation comprises a transfer of at least a portion of the liquidation value of the gift card to the beneficiary.

3. A method for generating a charitable donation based on a donor's gift card, the method comprising:
receiving information associated with the donor's gift card, wherein information comprises merchant information, numerical identifying information, expiration information, authorization codes, or any other identifying information associated with a merchant issued gift card;
validating the gift card balance, wherein validation comprises validating the authenticity of the card and the current balance available in dollars or other common currency;
liquidating the validated gift card, wherein liquidating comprises a transaction whereby a third party purchases the value of the gift card for an agreed upon value, such as by auction or over an exchange, and the sale price is deposited into an account for future retrieval;
transmitting all or a portion of the liquidated value by transferring funds from the account to a designated beneficiary in order to make the charitable donation;
retaining a portion of the funds from the liquidation, thereby collecting a processing fee;
sending an acknowledgment of the donation, such as a receipt by electronic means to the donor who donated the gift card, or storing the acknowledgment for later retrieval.
